(19) United States
(12) Patent Application Publication
(10) Pub. No.: US 2012/0177469 A1
(43) Pub. Date: Jul. 12, 2012

(54) Transport Device For Media Roll Used With Grand Format Printer

(75) Inventors: Dave Robbins, Little Rock, AR (US); Paul Browning, Morrilton, AR (US); Steve Russell, Benton, AR (US); Steve Shiew, Conway, AR (US); Mike Graves, North Little Rock, AR (US); David Totten, Enola, AR (US)

(73) Assignees: DBA Vestcome Retail Solutions; Electronic Imaging Services, Inc.

(21) Appl. No.: 13/005,368

(22) Filed: Jan. 12, 2011

(51) Int. Cl. B65G 47/90

(52) U.S. Cl. 414/626

(57) ABSTRACT

One transport device for media rolls used with grand format printers includes a base having opposed ends, means for coupling the base to a forklift tine, and two arms respectively adjacent the base ends. Each arm is coupled to the base for rotatable and lateral movement. A first hook extends from a first cable having an upper end coupled to one arm's distal end. The first hook has a receiving area configured to receive a shaft extending generally along the media roll's center axis, and position the shaft along a generally vertical line extending through the first cable upper end. A second hook extends from a second cable having an upper end coupled to the other arm's distal end. The second hook has a receiving area configured to receive the mounting shaft and position the mounting shaft along a generally vertical line extending through the second cable upper end.

### CROSS-REFERENCE TO RELATED APPLICATIONS

None.

### BACKGROUND

The invention relates generally to the field of printing. More specifically, the invention relates to the field of positioning media rolls used with wide (or “grand”) format printing.

Grand format printers are marketed by various companies. Examples include Durst, efiVutek, HP, Fuji, and others. While the size of media rolls (e.g., paper rolls, vinyl rolls, etc.) for use with the different grand format printers can vary, typical media rolls may be between about five and eight feet wide (or tall when stood upright along the axis of rotation) and may weigh up to about three hundred pounds. The size and weight of the media rolls can make the media rolls difficult and unsafe to transport between the printer and a storage location.

It is not uncommon in the prior art for multiple people or a traditional forklift (i.e., a forklift having a simple pair of tines) to place a media roll upon a set of jacks adjacent a grand format printer, and for people to turn/drop the media roll from the jacks to a mount location in the grand format printer. Similarly, to remove a media roll, people often lift the media roll from the grand format printer to atop a set of jacks, and then move the media roll from the jacks to its intended location. These practices are unsafe, however, as the opportunity for human injury is great in such routines when carrying the media roll, when placing the media roll upon the jacks, and when moving the media roll from the jacks to the mount location. Further, particularly when a media roll is dropped into a mount location, the opportunity for damage to the media roll and the grand format printer may be substantial.

### SUMMARY

The present invention is defined by the claims below. According to one embodiment, a transport device for a media roll used with a grand format printer includes an elongate rigid base having first and second opposed ends. A sleeve extends from the base for coupling the base to a tine of a forklift. A plurality of brackets extend from the base, and each of the brackets has a hole positioned above the base. A first arm is upwardly adjacent the base first end, and a second arm is upwardly adjacent the base second end. The first arm has proximal and distal ends and passes through at least one of the bracket holes for rotating and moving laterally relative to the base. The first arm has a stop for preventing the first arm from extending laterally beyond a predetermined position, and the first arm distal end has an offset portion that extends below the base first end when the first arm offset portion is freely suspended. The second arm has proximal and distal ends and passes through at least one other of the bracket holes for rotating and moving laterally relative to the base. The second arm has a stop for preventing the second arm from extending laterally beyond a predetermined position, and the second arm distal end has an offset portion that extends below the base second end when the second arm offset portion is freely suspended. A first flexible cable has an upper end coupled to the first arm offset portion, and a second flexible cable has an upper end coupled to the second arm offset portion. A first hook extends from the first cable, and a second hook extends from the second cable. The first hook has a receiving area configured to receive a mounting shaft that extends generally along an elongate center axis of the media roll, and position the mounting shaft along a generally vertical imaginary line extending through the first cable upper end when the first hook is freely suspended by the first cable. The second hook has a receiving area configured to receive the mounting shaft and position the mounting shaft along a generally vertical imaginary line extending through the second cable upper end when the second hook is freely suspended by the second cable.

According to another embodiment, a transport device for a media roll used with a grand format printer includes an elongate base having first and second opposed ends, and includes means for coupling the base to at least one tine of a forklift. A first arm is adjacent the base first end, and a second arm is adjacent the base second end. The first arm has proximal and distal ends and is coupled to the base for rotatable and lateral movement relative to the base; the second arm also has proximal and distal ends and is coupled to the base for rotatable and lateral movement relative to the base. A first flexible cable has an upper end coupled to the first arm distal end, and a first hook extends from the first cable. The first hook has a receiving area configured to receive a mounting shaft that extends generally along an elongate center axis of the media roll, and position the mounting shaft along a generally vertical imaginary line extending through the first cable upper end when the first hook is freely suspended by the first cable. A second flexible cable has an upper end coupled to the second arm distal end, and a second hook extends from the second cable. The second hook has a receiving area configured to receive the mounting shaft and position the mounting shaft along a generally vertical imaginary line extending through the second cable upper end when the second hook is freely suspended by the second cable.

According to still another embodiment, a transport device for a media roll used with a grand format printer includes an elongate base having first and second opposed ends. A sleeve extends from the base for coupling the base to a tine of a forklift. A first arm is adjacent the base first end, and a second arm is adjacent the base second end. The first arm has proximal and distal ends and is coupled to the base for lateral movement relative to the base; the second arm also has proximal and distal ends and is coupled to the base for lateral movement relative to the base. A first flexible cable has an upper end coupled to the first arm distal end, and a second flexible cable has an upper end coupled to the second arm distal end. A first hook extends from the first cable, and a second hook extends from the second cable. The first hook has a receiving area configured to receive a mounting shaft that extends generally along an elongate center axis of the media roll, and position the mounting shaft along a generally vertical imaginary line extending through the first cable upper end when the first hook is freely suspended by the first cable. The second hook has a receiving area configured to receive the mounting shaft and position the mounting shaft along a generally vertical imaginary line extending through the second cable upper end when the second hook is freely suspended by the second cable.

### BRIEF DESCRIPTION OF THE DRAWINGS

Illustrative embodiments of the present invention are described in detail below with reference to the attached drawings.

FIG. 1 is an isometric view of a transport device for media rolls used with grand format printers, according to an embodiment and shown with the arms retracted and with a forklift.

FIG. 2 is a front perspective view of the transport device and forklift of FIG. 1, with the hooks and cables shown at a storage configuration.

FIG. 3 is a front view of the transport device of FIG. 1, with the hooks and cables shown at a freely suspended configuration and with covering removed from one cable for illustration.

FIG. 4 is a top view of the transport device of FIG. 1, with the hooks and cables removed and with a portion of the forklift of FIG. 1 shown for illustration.

FIG. 5 is an isometric view of part of the transport device of FIG. 1, shown with an arm extended.

FIGS. 6 and 7 are isometric views showing part of the transport device of FIG. 1 in use with a typical media roll used with grand format printers.

### DETAILED DESCRIPTION

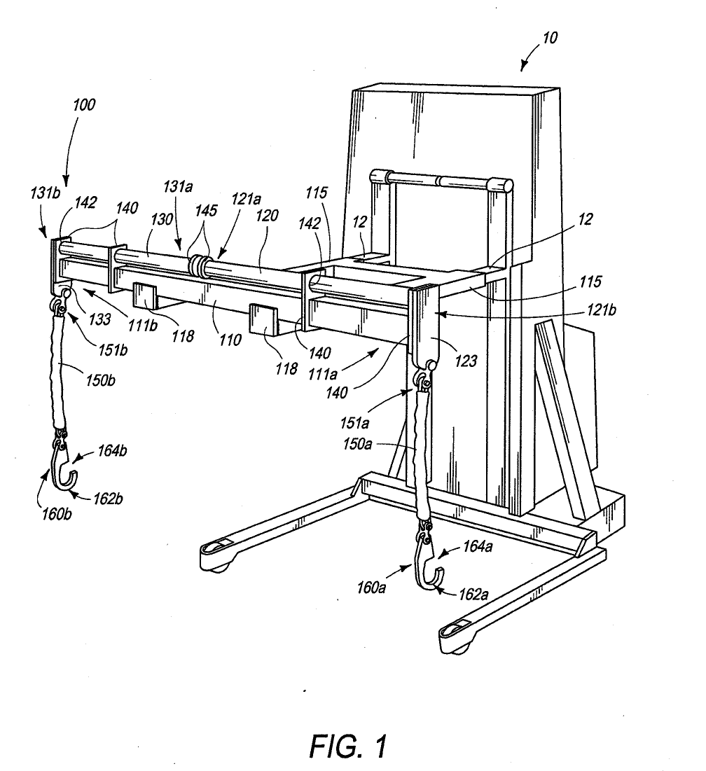

Transport devices for media rolls used with grand format printers are set forth herein. FIGS. 1 through 7 show one embodiment 100 of a transport device for media rolls used with grand format printers. The transport device 100 includes an elongate base 110 and a pair of arms 120, 130.

The elongate base 110 is generally rigid and includes opposed ends 111a, 111b. The elongate base 110 may be hollow or have a solid core, and may be constructed of various appropriate materials, such as square, rectangular, or round tube steel or aluminum; wood; composites; et cetera. Similarly, the elongate base 110 may be configured to have various lengths. However, it may be desirable for the elongate base 110 to be at least four to four and a half feet long.

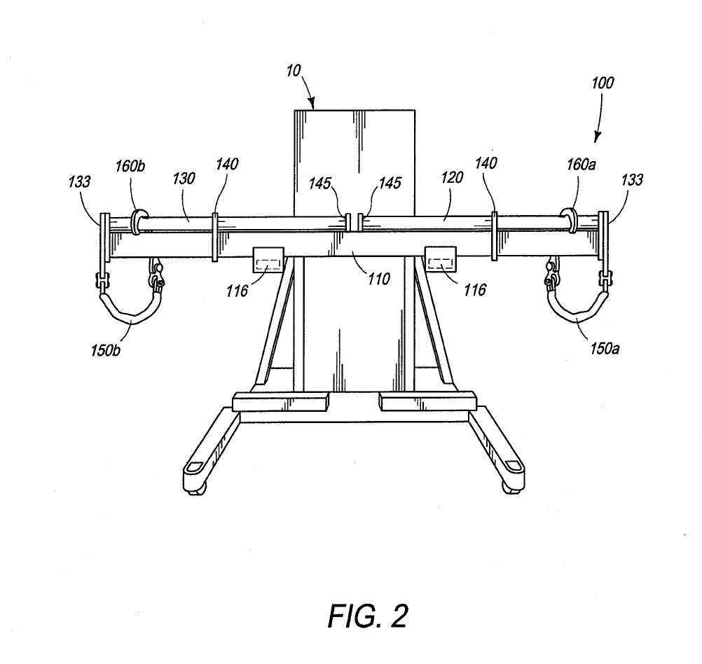

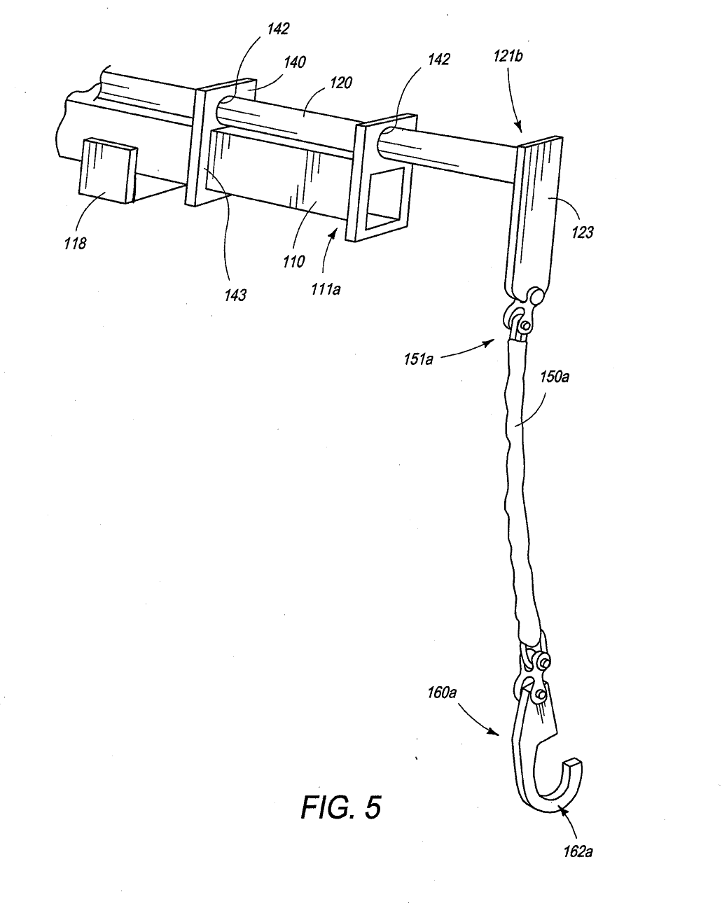

Means for coupling the base 110 to at least one tine 12 of a forklift 10 are included. Embodiment 100 includes two sleeves 115 extending from the base 110. In other embodiments, the base 110 may be clamped, bolted, welded, or adhered to at least one tine 12, and those skilled in the art will appreciate that other coupling methods may additionally be used. Returning to the embodiment 100, the sleeves 115 include cavities 116 (FIGS. 2 through 4) for receiving the tines 12, and pins 117 (FIG. 4) may pass through holes in the tines 12 to lock the sleeves 115 to the tines 12. The pins 117 are tethered to the base 110 to prevent losing the pins 117 when not in use. The base 110 is upwardly adjacent the sleeves 115 and may, for example, be coupled to the sleeves 115 by welding, adhesive, bolts, and/or clamps. A cover plate 118 (FIG. 1) may cover a front end of each sleeve 115 and also a portion of the base 110. As such, the cover plate 118 may help position the sleeves 115 about the tines 12 by restricting the tines 12 from passing entirely through the sleeves 115, and the cover plate 118 may further secure the sleeves 115 to the base 110.

The first and second arms 120, 130 have proximal ends 121a, 131a and distal ends 121b, 131b and are respectively adjacent the opposed ends 111a, 111b of the base 110. The proximal ends 121a, 131a are located between the distal ends 121b, 131b, and the arms 120, 130 are coupled to the base 110 for rotatable and lateral movement relative to the base 110. In the embodiment 100, the arms 120, 130 are upwardly adjacent the base ends 111a, 111b and are coupled to the base 110 generally in line with each other by brackets 140.

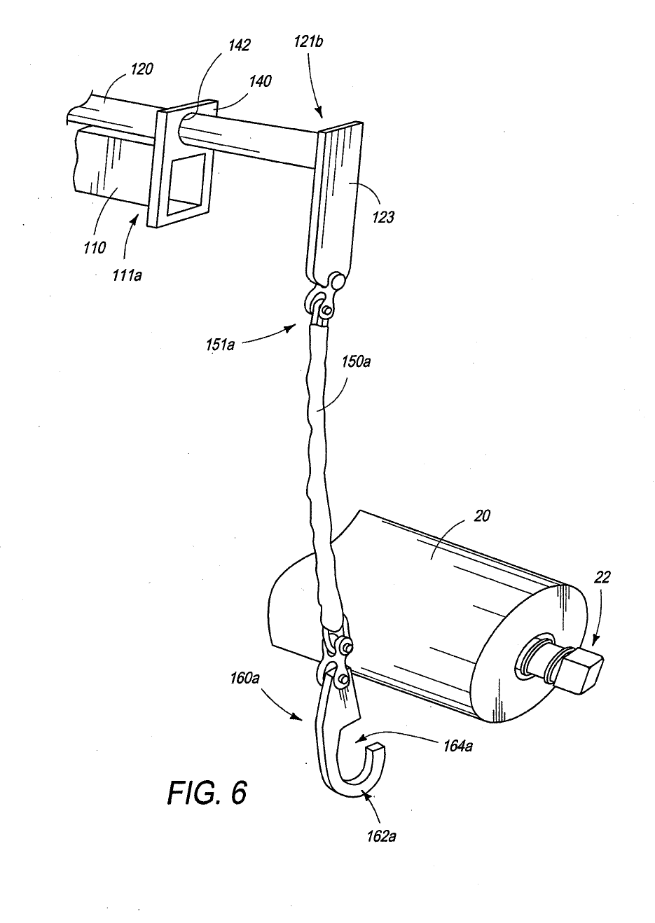

The brackets 140 extend from the base 110, and each of the brackets 140 has a hole 142 positioned above the base 110. The brackets 140 may be coupled to the base 110 in various ways; for example, each bracket 140 may additionally include another hole 143 (FIG. 5), the base 110 may pass through the holes 143, and the brackets 140 may be welded to the base 110.

Each arm 120, 130 passes through two of the bracket holes 142 (FIGS. 1 and 5) to provide sufficient support to the arms 120, 130 and also restrict the arms 120, 130 from moving laterally except for generally along an axis of movement. However, passing each arm 120, 130 through a single longer bracket is a substantially similar way of supporting the arms 120, 130 and restricting undesirable movement and may be utilized in various embodiments. Particularly to aid in allowing the arms 120, 130 to rotate relative to the base 110 (and the brackets 140), the bracket holes 142 and/or the arms 120, 130 may have a generally circular perimeter.

Stops 145 (FIGS. 1 through 4) extend from the arms 120, 130 (e.g., adjacent the proximal ends 121a, 131a) such that the proximal arm ends 121a, 131a remain upwardly adjacent the base 110. In other words, the stops 145 may prevent the arms 120, 130 from moving laterally beyond a predetermined extended position and undesirably separating from the base 110.

As best shown in FIGS. 5 through 7, the distal end 121b of the arm 120 may have an offset portion 123 that extends below the base end 111a when the offset portion 123 is freely suspended (i.e., when there are no external forces acting on the arm 120). The distal end 131b of the arm 130 may similarly have an offset portion 133 that extends below the base end 111b when the offset portion 133 is freely suspended (i.e., when there are no external forces acting on the arm 130), as shown in FIG. 1.

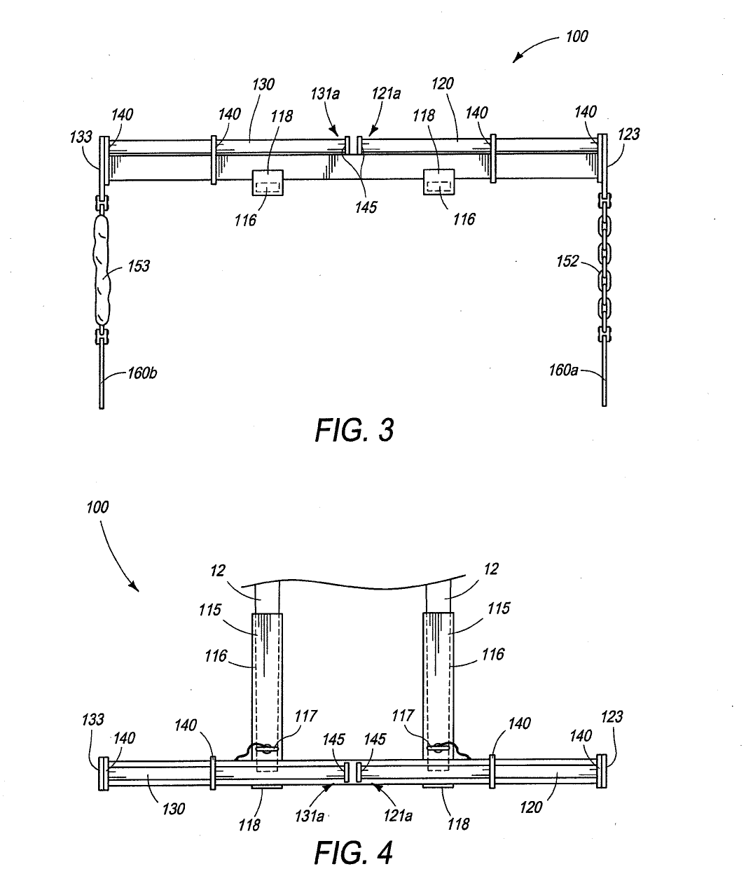

Respective flexible cables 150a, 150b extend from the arm distal ends 121b, 131b. More specifically, an upper end 151a of the flexible cable 150a may be coupled to the offset portion 123, and an upper end 151b of the flexible cable 150b may be coupled to the offset portion 133. The cables 150a, 150b shown in the drawings are constructed of chain 152 (FIG. 3) mostly encased by a covering 153 and are rotatably coupled to the offset portions 123, 133. Other appropriate cables may, for example, include rope, strap, and cord.

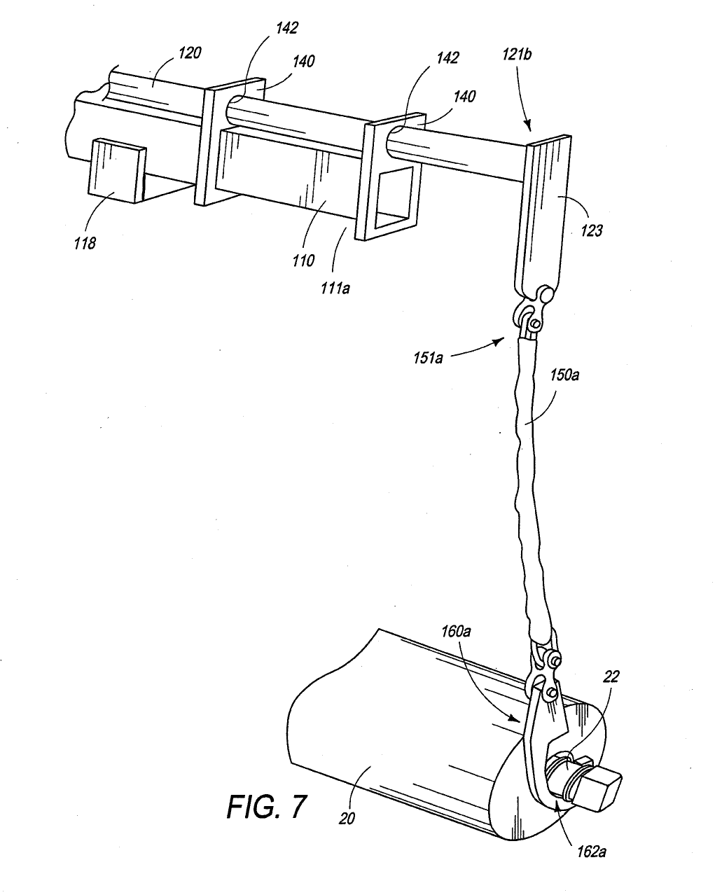

Hooks 160a, 160b respectively extend from the cables 150a, 150b, and may be rotatably coupled to the cables 150a, 150b (e.g., as shown in FIG. 5). The hook 160a has a receiving area 162a configured to receive a mounting shaft 22 (shown in FIGS. 6 and 7) that extends generally along an elongate center axis of a typical media roll 20 used with grand format printers, and to position the mounting shaft 22 along a generally vertical imaginary line extending through the cable upper end 151a when the hook 160a is freely suspended by the cable 150a. The hook 160b has a receiving area 162b configured to receive the mounting shaft 22 and position the mounting shaft 22 along a generally vertical imaginary line extending through the cable upper end 151b when the hook 160b is freely suspended by the cable 150b. Moreover, the hook receiving areas 162a, 162b and the arm offset portions 123, 133 may all generally lie along a common imaginary plane when the arm offset portions 123, 133 are freely suspended and the hooks 120, 130 are freely suspended by the cables 150a, 150b.

The receiving areas 162a, 162b may be lined with felt, may be rubberized, or may otherwise be covered/coated, and (as shown in FIG. 1) each hook 160a, 160b has an opening 164a, 164b for accessing the respective receiving areas 162a, 162b. The openings 164a, 164b face generally toward a rear end of the transport device 100, as shown in FIG. 1.

In use, the base 110 is coupled to the forklift 10 (e.g., by passing the tines 12 into the sleeves 115 and using the pins 117 to lock the sleeves 115 to the tines 12). The forklift 10 may then be used to move the transport device 100 to adjacent the media roll 20 (FIG. 6). While the hooks 160a, 160b are not in use with the media roll 20, the hooks 160a, 160b and cables 150a, 150b may be maintained at a storage configuration (FIG. 2), with the hooks 160a, 160b coupled to the arms 120, 130. Once adjacent the media roll 20, the arms 120, 130 may be extended (FIGS. 5 through 7) or retracted (FIGS. 1 through 4) if necessary to accommodate the media roll 20. The mounting shaft 22 may then be passed through the openings 164a, 164b, and the mounting shaft 22 may be received in the receiving areas 162a, 162b. The location of the openings 164a, 164b may aid in easily coupling the hooks 160a, 160b to the mounting shaft 22. The forklift 10 may then be used to transport the media roll 20 to a grand format printer, and the media roll 20 may be positioned directly from the hooks 160a, 160b onto the grand format printer. The flexibility of the cables 150a, 150b, the rotatable nature of the arms 120, 130, and the balance provided by the receiving areas 162a, 162b being biased to a location generally directly beneath the cable upper ends 151a, 151b may be particularly helpful in transporting the media roll 20 and unloading the media roll 20 directly into the grand format printer.

To remove the media roll 20 from the grand format printer, the hooks 160a, 160b may be placed such that the mounting shaft 22 enters the openings 164a, 164b, and the forklift 10 may raise the transport device 100. Raising the transport device 100 may in turn cause the media roll 20 to separate from the grand format printer, and the forklift 10 may be used to transport the media roll 20 to a desired location.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims.

The invention claimed is:

1. A transport device for a media roll used with a grand format printer, the media roll having a mounting shaft extending generally along an elongate center axis, the transport device comprising:
an elongate rigid base having first and second opposed ends;
a sleeve extending from the base for coupling the base to a tine of a forklift;
a plurality of brackets extending from the base, each of the brackets having a hole positioned above the base;
a first arm upwardly adjacent the base first end and a second arm upwardly adjacent the base second end; the first arm having proximal and distal ends and passing through at least one of the bracket holes for rotating and moving laterally relative to the base; the first arm having a stop for preventing the first arm from extending laterally beyond a predetermined position; the first arm distal end having an offset portion that extends below the base first end when the first arm offset portion is freely suspended; the second arm having proximal and distal ends and passing through at least one other of the bracket holes for rotating and moving laterally relative to the base; the second arm having a stop for preventing the second arm from extending laterally beyond a predetermined position; the second arm distal end having an offset portion that extends below the base second end when the second arm offset portion is freely suspended;
a first flexible cable having an upper end coupled to the first arm offset portion;
a first hook extending from the first cable, the first hook having a receiving area configured to receive the mounting shaft and position the mounting shaft along a generally vertical imaginary line extending through the first cable upper end when the first hook is freely suspended by the first cable;
a second flexible cable having an upper end coupled to the second arm offset portion; and
a second hook extending from the second cable, the second hook having a receiving area configured to receive the mounting shaft and position the mounting shaft along a generally vertical imaginary line extending through the second cable upper end when the second hook is freely suspended by the second cable.

2. The transport device of claim 1, wherein at least one of the bracket holes, the first arm, and the second arm has a generally circular perimeter.

3. The transport device of claim 2, wherein the base is upwardly adjacent the sleeve and a cover plate covers one end of the sleeve and a portion of the base.

4. The transport device of claim 3, wherein: the first flexible cable upper end is rotatably coupled to the first arm offset portion; the second flexible cable upper end is rotatably coupled to the second arm offset portion; the first hook is rotatably coupled to the first cable; and
the second hook is rotatably coupled to the second cable.

5. The transport device of claim 4, wherein the first hook has an opening for accessing the first hook receiving area and the second hook has an opening for accessing the second hook receiving area, the first and second hook openings facing generally toward a rear end of the transport device.

6. The transport device of claim 5, wherein the first arm stop is adjacent the first arm proximal end, and wherein the second arm stop is adjacent the second arm proximal end.

7. The transport device of claim 6, wherein the first cable comprises chain at least partially encased by a covering, and wherein the second cable comprises chain at least partially encased by a covering.

8. The transport device of claim 1, wherein the base, the first hook receiving area, the second hook receiving area, the first arm offset portion, and the second arm offset portion generally lie along a common imaginary plane when the first arm offset portion and the second arm offset portion are freely suspended and the first and second hooks are freely suspended by the first and second cables.

9. A transport device for a media roll used with a grand format printer, the media roll having a mounting shaft extending generally along an elongate center axis, the transport device comprising:
an elongate base having first and second opposed ends;
means for coupling the base to at least one tine of a forklift;
a first arm adjacent the base first end and a second arm adjacent the base second end; the first arm having proximal and distal ends and being coupled to the base for rotatable and lateral movement relative to the base; the second arm having proximal and distal ends and being coupled to the base for rotatable and lateral movement relative to the base;
a first flexible cable having an upper end coupled to the first arm distal end;
a first hook extending from the first cable, the first hook having a receiving area configured to receive the mounting shaft and position the mounting shaft along a generally vertical imaginary line extending through the first cable upper end when the first hook is freely suspended by the first cable;
a second flexible cable having an upper end coupled to the second arm distal end; and
a second hook extending from the second cable, the second hook having a receiving area configured to receive the mounting shaft and position the mounting shaft along a generally vertical imaginary line extending through the second cable upper end when the second hook is freely suspended by the second cable.

10. The transport device of claim 9, wherein the first arm proximal end and the second arm proximal end are upwardly adjacent the base.

11. The transport device of claim 10, wherein the means for coupling includes a sleeve extending from the base for coupling the base to a tine of a forklift.

12. The transport device of claim 11, wherein the first hook has an opening for accessing the first hook receiving area and the second hook has an opening for accessing the second hook receiving area, the first and second hook openings facing generally toward a rear end of the transport device.

13. A transport device for a media roll used with a grand format printer, the media roll having a mounting shaft extending generally along an elongate center axis, the transport device comprising:
an elongate base having first and second opposed ends;
a sleeve extending from the base for coupling the base to a tine of a forklift;
a first arm adjacent the base first end and a second arm adjacent the base second end; the first arm having proximal and distal ends and being coupled to the base for lateral movement relative to the base; the second arm having proximal and distal ends and being coupled to the base for lateral movement relative to the base;
a first flexible cable having an upper end coupled to the first arm distal end;
a first hook extending from the first cable, the first hook having a receiving area configured to receive the mounting shaft and position the mounting shaft along a generally vertical imaginary line extending through the first cable upper end when the first hook is freely suspended by the first cable;
a second flexible cable having an upper end coupled to the second arm distal end; and
a second hook extending from the second cable, the second hook having a receiving area configured to receive the mounting shaft and position the mounting shaft along a generally vertical imaginary line extending through the second cable upper end when the second hook is freely suspended by the second cable.

14. The transport device of claim 13, wherein the first arm proximal end and the second arm proximal end are upwardly adjacent the base.

15. The transport device of claim 14, wherein the first hook has an opening for accessing the first hook receiving area and the second hook has an opening for accessing the second hook receiving area, the first and second hook openings facing generally toward a rear end of the transport device.

16. The transport device of claim 15, wherein the base is upwardly adjacent the sleeve and a cover plate covers one end of the sleeve and a portion of the base.

17. The transport device of claim 13, wherein: a plurality of brackets extend from the base, each of the brackets having a hole positioned above the base; the first arm passes through at least one of the bracket holes; and the second arm passes through at least one other of the bracket holes.
